(19) United States
(12) Patent Application Publication
(10) Pub. No.: US 2026/0135684 A1
(43) Pub. Date: May 14, 2026

(54) RANDOM ACCESS FOR LOW-DUTY-CYCLE TIME DIVISION DUPLEXING IN WIRELESS COMMUNICATIONS

(71) Applicant: QUALCOMM Incorporated, San Diego, CA (US)

(72) Inventors: Ayan SENGUPTA, Mountain View, CA (US); Alberto RICO ALVARINO, San Diego, CA (US)

(21) Appl. No.: 19/380,528

(22) Filed: Nov. 5, 2025

Related U.S. Application Data
(60) Provisional application No. 63/718,495, filed on Nov. 8, 2024.

(51) Int. Cl. H04L 5/14; H04L 5/00; H04W 74/00

(52) U.S. Cl. CPC H04L 5/14; H04L 5/0091; H04W 74/006

(57) ABSTRACT

Methods, systems, and devices for wireless communications are described that provide for random access techniques for low duty-cycle time division duplexing (TDD) communications. Random access preamble transmissions may use transmission resources associated with one or more preamble repetition units (PRUs), where a PRU may at least partially overlap with transmission resources that are not valid for a transmission. In such cases, all or a portion of the random access transmissions of the PRU may be postponed to a next valid uplink communication resource. Postponement of random access transmissions may be performed at a symbol-group level for symbol groups within a PRU, or at a PRU level. Further, radio network temporary identifiers (RNTIs) associated with random access transmissions may be identified based on a system frame associated with an initial transmission occasion of the random access transmission, or the postponed transmission occasion.

### CROSS REFERENCES

The present Application for Patent claims benefit of U.S. Provisional Patent Application No. 63/718,495 by SENGUPTA et al., entitled “RANDOM ACCESS FOR LOW-DUTY-CYCLE TIME DIVISION DUPLEXING IN WIRELESS COMMUNICATIONS,” filed Nov. 8, 2024, assigned to the assignee hereof, and expressly incorporated herein.

### FIELD OF TECHNOLOGY

The following relates to wireless communications, including random access for low-duty-cycle time division duplexing in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determining a time division duplexing configuration that indicates a first set of valid subframes for uplink communications and a second set of invalid subframes for uplink communications, where at least a first invalid subframe is located between a first uplink frame and a second uplink frame of the first set of valid subframes, deferring transmission of at least a portion of a first preamble repetition unit from the first uplink frame to the second uplink frame based on one or more symbol groups of the first preamble repetition unit that is selected for transmission of a random access preamble overlapping with the first invalid subframe, and transmitting at least the portion of the first preamble repetition unit in the second uplink frame.

A UE for wireless communications is described. The UE may include one or more memories storing processor executable code, and one or more processors coupled with the one or more memories. The one or more processors may individually or collectively be operable to execute the code to cause the UE to receive configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determine a time division duplexing configuration that indicates a first set of valid subframes for uplink communications and a second set of invalid subframes for uplink communications, where at least a first invalid subframe is located between a first uplink frame and a second uplink frame of the first set of valid subframes, defer transmission of at least a portion of a first preamble repetition unit from the first uplink frame to the second uplink frame based on one or more symbol groups of the first preamble repetition unit that is selected for transmission of a random access preamble overlapping with the first invalid subframe, and transmit at least the portion of the first preamble repetition unit in the second uplink frame.

Another UE for wireless communications is described. The UE may include means for receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes, means for deferring transmission of at least a portion of a first preamble repetition unit from the first uplink frame to the second uplink frame based on one or more symbol groups of the first preamble repetition unit that is selected for transmission of a random access preamble overlapping with the first invalid subframe, and means for transmitting at least the portion of the first preamble repetition unit in the second uplink frame.

A non-transitory computer-readable medium storing code for wireless communications is described. The code may include instructions executable by one or more processors to receive configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determine a time division duplexing configuration that indicates a first set of valid subframes for uplink communications and a second set of invalid subframes for uplink communications, where at least a first invalid subframe is located between a first uplink frame and a second uplink frame of the first set of valid subframes, defer transmission of at least a portion of a first preamble repetition unit from the first uplink frame to the second uplink frame based on one or more symbol groups of the first preamble repetition unit that is selected for transmission of a random access preamble overlapping with the first invalid subframe, and transmit at least the portion of the first preamble repetition unit in the second uplink frame.

In some examples of the method, UEs, and non-transitory computer-readable medium described herein, the deferring may include operations, features, means, or instructions for determining that at least a first symbol group of the first preamble repetition unit is within the first uplink frame and that at least a second symbol group of the first preamble repetition unit overlaps with the first invalid subframe, transmitting the first symbol group of the first preamble repetition unit, and deferring transmission of the second symbol group to the second uplink frame. In some examples of the method, UEs, and non-transitory computer-readable medium described herein, the deferring may include operations, features, means, or instructions for determining that at least a first symbol group of the first preamble repetition unit is within the first uplink frame and that at least a second symbol group of the first preamble repetition unit overlaps with the first invalid subframe and deferring transmission of the first preamble repetition unit in its entirety to the second uplink frame. In some examples of the method, UEs, and non-transitory computer-readable medium described herein, a non-integer quantity of preamble repetition units can be transmitted in each valid uplink frame.

Some examples of the method, UEs, and non-transitory computer-readable medium described herein may further include operations, features, means, or instructions for monitoring for a random access response associated with the random access preamble based on a random access (RA) radio network temporary identifier (RNTI) that is identified based on the first preamble repetition unit used for transmission of the random access preamble. In some examples of the method, UEs, and non-transitory computer-readable medium described herein, the RA-RNTI is identified based on a system frame number (SFN) identifier associated with the first uplink frame. In some examples of the method, UEs, and non-transitory computer-readable medium described herein, the RA-RNTI is identified based on a SFN identifier associated with the second uplink frame.

A method for wireless communications by a network entity is described. The method may include outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determining a time division duplexing configuration that indicates a first set of valid subframes for uplink communications and a second set of invalid subframes for uplink communications, where at least a first invalid subframe is located between a first uplink frame and a second uplink frame of the first set of valid subframes, and obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

A network entity for wireless communications is described. The network entity may include one or more memories storing processor executable code, and one or more processors coupled with the one or more memories. The one or more processors may individually or collectively be operable to execute the code to cause the network entity to output configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determine a time division duplexing configuration that indicates a first set of valid subframes for uplink communications and a second set of invalid subframes for uplink communications, where at least a first invalid subframe is located between a first uplink frame and a second uplink frame of the first set of valid subframes, and obtain at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

Another network entity for wireless communications is described. The network entity may include means for outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes, and means for obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

A non-transitory computer-readable medium storing code for wireless communications is described. The code may include instructions executable by one or more processors to output configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units, determine a time division duplexing configuration that indicates a first set of valid subframes for uplink communications and a second set of invalid subframes for uplink communications, where at least a first invalid subframe is located between a first uplink frame and a second uplink frame of the first set of valid subframes, and obtain at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

In some examples of the method, network entities, and non-transitory computer-readable medium described herein, the obtaining may include operations, features, means, or instructions for determining that at least a first symbol group of the first preamble repetition unit is within the first uplink frame and that at least a second symbol group of the first preamble repetition unit overlaps with the first invalid subframe, obtaining the first symbol group of the first preamble repetition unit via the first uplink frame, and obtaining the second symbol group of the first preamble repetition unit via the second uplink frame. In some examples of the method, network entities, and non-transitory computer-readable medium described herein, the obtaining the random access message may include operations, features, means, or instructions for determining that at least a first symbol group of the first preamble repetition unit is within the first uplink frame and that at least a second symbol group of the first preamble repetition unit overlaps with the first invalid subframe and obtaining the first preamble repetition unit in its entirety via the second uplink frame. In some examples of the method, network entities, and non-transitory computer-readable medium described herein, a non-integer quantity of preamble repetition units can be transmitted in each valid uplink frame.

Some examples of the method, network entities, and non-transitory computer-readable medium described herein may further include operations, features, means, or instructions for outputting a random access response associated with the random access preamble based on a random access RA-RNTI that may be identified based on the first preamble repetition unit used for transmission of the random access preamble. In some examples of the method, network entities, and non-transitory computer-readable medium described herein, the RA-RNTI may be identified based on a SFN identifier associated with the first uplink frame. In some examples of the method, network entities, and non-transitory computer-readable medium described herein, the RA-RNTI may be identified based on a SFN identifier associated with the second uplink frame.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access for low-duty-cycle time division duplexing in wireless communications in accordance with one or more aspects of the present disclosure.

FIG. 2 shows an example of a time division duplexing (TDD) pattern that supports random access for low-duty-cycle time division duplexing in wireless communications in accordance with one or more aspects of the present disclosure.

FIG. 3 shows an example of a preamble repetition unit (PRU) pattern that supports random access for low-duty-cycle time division duplexing in wireless communications in accordance with one or more aspects of the present disclosure.

FIGS. 4 and 5 show examples of deferred PRU patterns that support random access for low-duty-cycle time division duplexing in wireless communications in accordance with one or more aspects of the present disclosure.

FIG. 6 shows an example of a process flow that supports random access for low-duty-cycle time division duplexing in wireless communications in accordance with one or more aspects of the present disclosure.

FIGS. 7 and 8 show block diagrams of devices that support random access for low-duty-cycle time division duplexing in wireless communications in accordance with one or more aspects of the present disclosure.

FIG. 9 shows a block diagram of a communications manager that supports random access for low-duty-cycle time division duplexing in wireless communications in accordance with one or more aspects of the present disclosure.

FIG. 10 shows a diagram of a system including a device that supports random access for low-duty-cycle time division duplexing in wireless communications in accordance with one or more aspects of the present disclosure.

FIGS. 11 and 12 show block diagrams of devices that support random access for low-duty-cycle time division duplexing in wireless communications in accordance with one or more aspects of the present disclosure.

FIG. 13 shows a block diagram of a communications manager that supports random access for low-duty-cycle time division duplexing in wireless communications in accordance with one or more aspects of the present disclosure.

FIG. 14 shows a diagram of a system including a device that supports random access for low-duty-cycle time division duplexing in wireless communications in accordance with one or more aspects of the present disclosure.

FIGS. 15 through 20 show flowcharts illustrating methods that support random access for low-duty-cycle time division duplexing in wireless communications in accordance with one or more aspects of the present disclosure.

### DETAILED DESCRIPTION

Some wireless communications systems may use time division duplexing (TDD) for wireless communications, in which different time durations (e.g., radio frames, radio subframes, orthogonal frequency division multiplexing (OFDM) symbols, etc.) may be available for an uplink or a downlink transmission, and other time durations are unavailable for uplink or downlink transmissions. In some cases, a TD pattern may include a set of valid time resources, and a set of invalid time resources, where valid time resources may be used for uplink communications, downlink communications, or both. In some implementations, TDD patterns with valid and invalid time resources may be used in a non-terrestrial network (NTN). An NTN may be a network involving communication between two or more devices with at least one of the devices being a non-terrestrial device, such as a satellite. For example, an NTN may be a network that combines satellites, drones, high-altitude platforms, and/or (ground) base stations to extend cellular connectivity for user equipments (UEs) across various geographic locations. In such examples, a UE communicating over or via an NTN may include a UE communicating (e.g., transmitting and/or receiving) with a satellite in orbit.

As discussed herein, some NTNs may support a TDD pattern according to which a subset of frames are valid in a configured, repetitive pattern. For example, some NTNs may support a TDD pattern according to which k out of every N frames are valid uplink frames, with k being any numeric quantity and N indicating (e.g., defining) a periodicity of (sets of) valid uplink frames. The UE may transmit uplink messaging via valid uplink frames and may refrain from transmitting uplink messaging via invalid uplink frames (uplink frames that are not valid uplink frames) in accordance with the TDD pattern. Additionally, some UEs communicating over or via an NTN may perform random access procedures in which a physical random access channel (PRACH) preamble may be transmitted to initiate a random access procedure, such as for initial network access.

In some scenarios, a network entity may configure random access resources for transmission of random access preambles. Such random access resources may be configured as a set of symbol groups that may be used to transmit repetitions of a random access preamble, where the set of symbol groups may form a preamble repetition unit (PRU). In some implementations in which the UE communicates in accordance with a TDD pattern that specifies a periodicity of valid uplink frames (e.g., with k out of N frames being valid uplink frames) and performs segmented pre-compensation, the UE may experience situations in which one or more symbol groups of a PRU may overlap with an invalid frame (e.g., one or more invalid subframes of an invalid frame).

In accordance with various aspects, if a symbol group of a PRU overlaps with an invalid uplink frame of a TDD pattern, all or a portion of the PRACH transmissions of the PRU may be postponed to the next valid uplink frame. In some aspects, postponement or deferral of PRACH preamble transmissions may be performed at a symbol-group level. In such aspects, if a symbol group of a PRU overlaps with an invalid uplink occasion with respect to the TDD pattern, the PRACH preamble transmissions of the overlapping symbol group(s) is postponed to the next valid uplink transmission occasion from that symbol group onward. In other aspects, postponement or deferral of PRACH preamble transmissions may be performed at a PRU-level. In such aspects, if a symbol group of a PRU overlaps with an invalid uplink occasion with respect to the TDD pattern, the PRACH transmissions are postponed to the next valid uplink transmission occasion from the interrupted PRU onward.

Additionally, in some aspects, a random-access (RA) radio network temporary identifier (RNTI) that is used by the UE to monitor a control channel transmission (e.g., a physical downlink control channel (PDCCH) with a random access response), in response to a PRACH transmission may calculated according to the first radio frame (e.g., a first system frame number (SFN)) in which the PRACH resource starts. In some aspects, when PRU-level PRACH postponement is used, when the start of the PRACH transmissions is postponed due to collision with an invalid TDD uplink occasion, the SFN identifier (SFN_id) used to calculate the RA-RNTI is the SFN id prior to postponement. In other aspects, when the start of the PRACH is postponed due to collision with an invalid TDD uplink occasion, the SFN_id used to calculate the RA-RNTI is the SFN_id after postponement. In any of these described aspects, both the transmitting UE and the receiving network entity may be aware of whether a PRACH overlaps with an invalid TDD uplink occasion, and may select the appropriate RA RNTI associated with the random access response.

Particular aspects of the subject matter described herein may be implemented to realize one or more of the following advantages. For example, by deferring all or a portion of preamble transmissions of a PRU in accordance with a PRU interruption due to an invalid uplink frame, the UE may maintain PRU characteristics that may allow transmission and reception of repetitions of random access preambles, which may enhance the likelihood of successful receipt of a random access preamble at a network entity (e.g., a satellite in an NTN) while supporting various TDD patterns, including TDD patterns with relatively low duty-cycles (e.g., TDD patterns with relatively infrequent valid uplink frames). Such greater likelihood of random access preamble reception may provide greater communication reliability between the UE and the network entity, and may allow the UE to achieve or facilitate greater throughput, which may support higher data rates, greater system capacity, and greater spectral efficiency, among other benefits. Further, by providing techniques to determine a RA-RNTI for a random access response message, ambiguity associated with a RA-RNTI may be avoided. Moreover, by supporting reliable random access transmissions, with reduced ambiguity of a RA-RNTI, over or via an NTN that is able to accommodate various TDD patterns, the described techniques may support enhanced coexistence across various devices, systems, networks, technologies, and protocols.

Aspects of the disclosure are initially described in the context of wireless communications systems. Aspects of the disclosure are further illustrated by and described with reference to a TDD pattern, PRU patterns, PRU deferral patterns, apparatus diagrams, system diagrams, and flowcharts that relate to random access for low-duty-cycle time division duplexing in wireless communications.

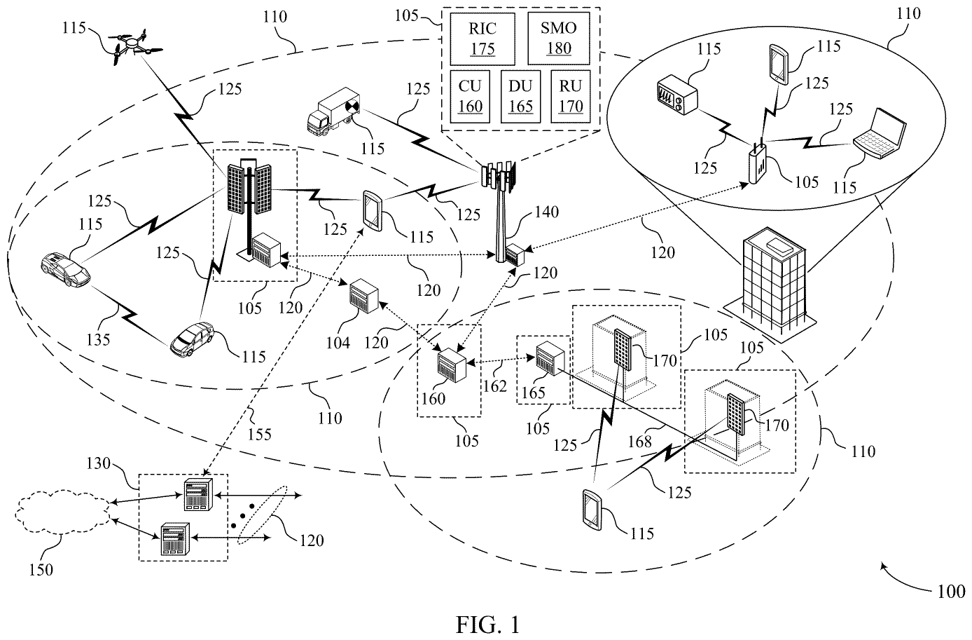

FIG. 1 shows an example of a wireless communications system 100 that supports random access for low-duty-cycle time division duplexing in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support segmented pre-compensation schemes for time division duplexing in a non-terrestrial network as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In some aspects, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may include, support, or be an example of one or more NTNs. An NTN may be a network involving communication between two or more devices with at least one of the devices being a non-terrestrial device, such as a satellite. For example, an NTN may be a network that combines satellites, drones, high-altitude platforms, and/or (ground) base stations to extend cellular connectivity for UEs 115 across various geographic locations. In such examples, a UE 115 communicating over or via an NTN may include a UE 115 communicating with a satellite in orbit. Some NTNs may support a TDD pattern according to which a subset of frames are valid in a configured, repetitive pattern. For example, some NTNs may support a TDD pattern according to which k out of every N frames are valid uplink frames, with k being any numeric quantity (e.g., 1, 2, or 3) and N indicating (e.g., defining) a periodicity of valid uplink frames. The UE 115 may transmit uplink messaging via valid uplink frames and may refrain from transmitting uplink messaging via invalid uplink frames in accordance with the TDD pattern. The uplink messaging that the UE 115 may transmit may include physical uplink shared channel (PUSCH) transmissions and/or physical random access channel (PRACH) transmissions, among other examples. Further, in examples in which the UE 115 supports NB-IoT communication, such uplink messaging may be understood as NB PUSCH (NPUSCH) and/or NB PRACH (NPRACH), among other examples.

In accordance with various aspects, a UE 115 may transmit one or more repetitions of a PRACH preamble associated with a random access request. In some aspects, the repetitions of the PRACH preamble may be associated with a PRU, and if a symbol group of a PRU overlaps with an invalid uplink frame of a TDD pattern, all or a portion of the PRACH transmissions of the PRU may be postponed to the next valid uplink frame. In some aspects, postponement or deferral of PRACH preamble transmissions may be performed at a symbol-group level. In such aspects, if a symbol group of a PRU overlaps with an invalid uplink occasion with respect to the TDD pattern, the PRACH preamble transmissions of the overlapping symbol group(s) is postponed to the next valid uplink transmission occasion from that symbol group onward. In other aspects, postponement or deferral of PRACH preamble transmissions may be performed at a PRU-level. In such aspects, if a symbol group of a PRU overlaps with an invalid uplink occasion with respect to the TDD pattern, the PRACH transmissions are postponed to the next valid uplink transmission occasion from the interrupted PRU onward.

Additionally, in some aspects, a RA-RNTI that is used by the UE 115 to monitor a control channel transmission (e.g., a PDCCH with a random access response), in response to a PRACH transmission may calculated according to the first radio frame (e.g., a first SFN) in which the PRACH resource starts. In some aspects, when PRU-level PRACH postponement is used, when the start of the PRACH transmissions is postponed due to collision with an invalid TDD uplink occasion, the SFN_id used to calculate the RA-RNTI is the SFN_id prior to postponement. In other aspects, when the start of the PRACH is postponed due to collision with an invalid TDD uplink occasion, the SFN_id used to calculate the RA-RNTI is the SFN_id after postponement.

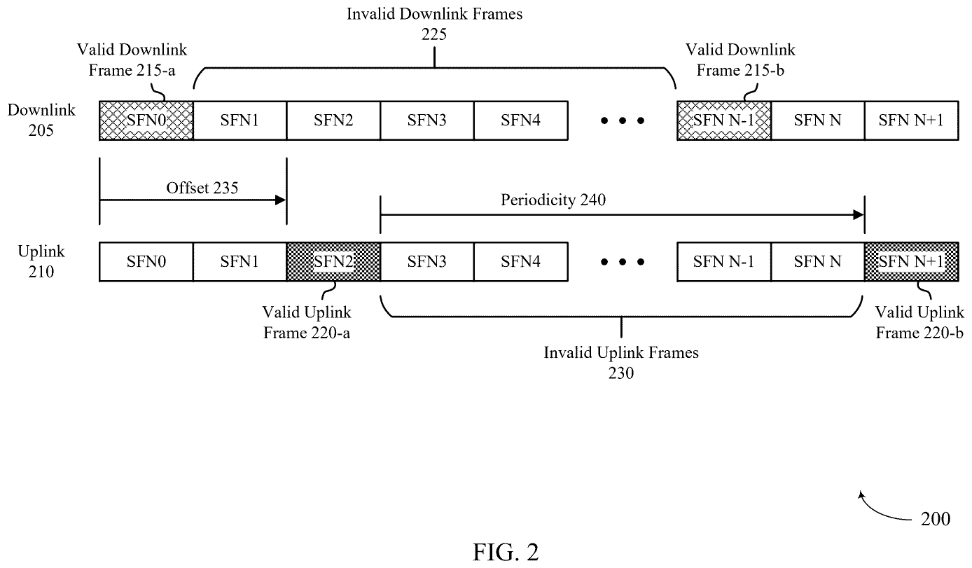

FIG. 2 shows an example of a time division duplexing (TDD) pattern 200 that supports random access for low-duty-cycle time division duplexing in wireless communications in accordance with one or more aspects of the present disclosure. The TDD pattern 200 may be implemented in accordance with one or more aspects of the wireless communications system 100. For example, a UE 115 (e.g., a UE 115, which in some examples may be a NB-IoT device) may communicate over or via an NTN in accordance with the TDD pattern 200. In other words, the TDD pattern 200 may be associated with NTN communication between the UE 115 and a network entity 105 (e.g., a satellite) and may facilitate NB-IoT over an NTN.

The TDD pattern 200 may include a downlink 205 associated with periodic valid downlink frames (e.g., which include valid downlink subframes) and an uplink 210 associated with periodic valid uplink frames (e.g., which include valid uplink subframes). The downlink 205 may be associated with non-consecutive sets of valid downlink frames including a valid downlink frame 215-a and a valid downlink frame 215-b. The valid downlink frame 215-a and the valid downlink frame 215-b may be associated with (e.g., used for) NTN communication from the network entity 105 to the UE 115. By way of further example, the uplink 210 may be associated with non-consecutive sets of valid uplink frames including a valid uplink frame 220-a and a valid uplink frame 220-b. The valid uplink frame 220-a and the valid uplink frame 220-b may be associated with (e.g., used for) NTN communication from the UE 115 to the network entity 105.

A remainder of frames associated with the downlink 205 and the uplink 210, outside of the valid frames, may be understood as invalid frames. For example, the downlink 205 may be associated with a set of invalid downlink frames 225 between the valid downlink frame 215-a and the valid downlink frame 215-b. The UE 115 may not expect to receive NTN communication from the network entity 105 via an invalid downlink frame. By way of further example, the uplink 210 may be associated with a set of invalid uplink frames 230 (which may include at least a first invalid frame) between the valid uplink frame 220-a (which may be an example of a first uplink frame) and the valid uplink frame 220-b (which may be an example of a second uplink frame). The UE 115 may refrain from transmitting NTN communication to the network entity 105 via an invalid uplink frame.

In some aspects, the TDD pattern 200 may be associated with an offset 235 between the downlink 205 and the uplink 210. The offset 235, which may be understood as a downlink-uplink offset, may be an offset for downlink-uplink separation in time, such as a scheduling offset used in uplink-downlink timing relationships in NTN. In accordance with the offset 235, the TDD pattern 200 may be understood or referred to as half-duplex at the network level (because of the time domain separation between the downlink 205 and the uplink 210, which may be associated with different carriers or frequency bands in some implementations). For example, in accordance with the offset 235, one or more first radio frames out of a set of (e.g., N) radio frames may be used for uplink and one or more second radio frames out of the set of radio frames may be used for downlink, the one or more first radio frames being non-overlapping with the one or more second radio frames.

The TDD pattern 200 may further be associated with (or otherwise based on) a periodicity 240 of valid frames. As illustrated in the example of the TDD pattern 200, the periodicity 240 may be of valid uplink frames associated with the NTN communication between the UE 115 and the network entity 105. Additionally, or alternatively, the periodicity 240 may be of valid downlink frames associated with the NTN communication between the UE 115 and the network entity 105. The periodicity 240 may be associated with (e.g., define) a duty-cycle of the TDD pattern 200. In examples in which the periodicity 240 satisfies a threshold (e.g., is greater than or equal to a threshold), the TDD pattern 200 may be an example of a low duty-cycle TDD mode of operation to facilitate NB-IoT over the NTN. Further, in accordance with the periodicity 240, the TDD pattern 200 may be associated with a k out of N approach to NTN communication, such that k (downlink or uplink) frames are available (usable or valid) for NTN communication out of a set of N (downlink or uplink) frames, where k may be any numeric quantity, such as one, two, three, four, and so on. A set of k valid (downlink or uplink) frames may occur in accordance with the periodicity 240. In some aspects, the UE 115 may receive an indication of N via a signaled parameter, such as a selective Availability-periodicity parameter.

Some systems, however, may lack mechanisms to support such a low duty-cycle mode of operation (e.g., in NB-IoT). For example, due to sparse and discontinuous availability of uplink and downlink resources, several aspects (e.g., mapping physical channels to time domain resources, applying transformations to physical channels, or validity durations for some timers) may be affected differently than in systems without such a low duty-cycle mode of operation. Some implementations of the present disclosure support one or more signaling- or configurational-based mechanisms according to which the UE 115 and/or the network entity 105 may support uplink time or frequency pre-compensation on account of a low duty-cycle TDD mode of operation.

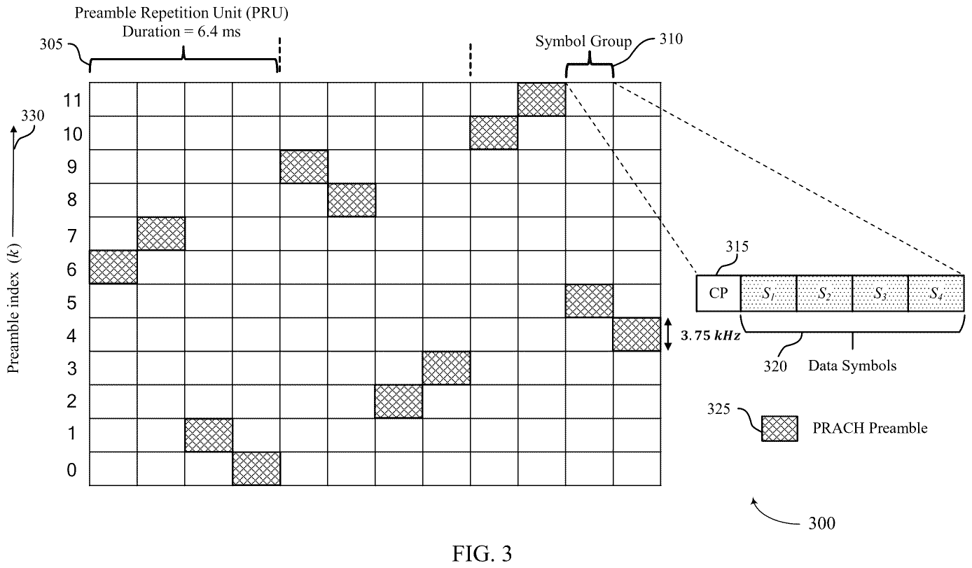

For example, in accordance with various aspects, a UE may transmit one or more repetitions of a PRACH preamble associated with a random access request. In some aspects, the repetitions of the PRACH preamble may be associated with a PRU, and if a symbol group of a PRU overlaps with an invalid uplink frame of a TDD pattern, all or a portion of the PRACH transmissions of the PRU may be postponed to the next valid uplink frame. Examples of PRACH resources for RACH preamble transmissions are discussed with reference to FIGS. 3 through 5. In some aspects, postponement or deferral of PRACH preamble transmissions may be performed at a symbol-group level. In such aspects, if a symbol group of a PRU overlaps with an invalid uplink occasion with respect to the TDD pattern, the PRACH preamble transmissions of the overlapping symbol group(s) is postponed to the next valid uplink transmission occasion from that symbol group onward. In other aspects, postponement or deferral of PRACH preamble transmissions may be performed at a PRU-level. In such aspects, if a symbol group of a PRU overlaps with an invalid uplink occasion with respect to the TDD pattern, the PRACH transmissions are postponed to the next valid uplink transmission occasion from the interrupted PRU onward.

Additionally, in some aspects, a RA-RNTI that is used by the UE 115 to monitor a control channel transmission (e.g., a PDCCH with a random access response), in response to a PRACH transmission may calculated according to the first radio frame (e.g., a first SFN) in which the PRACH resource starts. For example, the RA-RNTI that is used by the UE to monitor PDCCH, in response to a PRACH transmission, is calculated according to the first radio frame, such as according to:

$$RA - RNTI = 1 + floor ( SFN\_id / 4 ) + 256 * carrier\_id$$

where SFN_id is the index of the first radio frame of the specified PRACH and carrier_id is the index of the uplink carrier associated with the specified PRACH. The carrier_id of the anchor carrier is 0.

In some aspects, when PRU-level PRACH postponement is used, when the start of the PRACH transmissions is postponed due to collision with an invalid TDD uplink occasion, the SFN_id used to calculate the RA-RNTI is the SFN_id prior to postponement. In other aspects, when the start of the PRACH is postponed due to collision with an invalid TDD uplink occasion, the SFN_id used to calculate the RA-RNTI is the SFN_id after postponement.

FIG. 3 shows an example of a PRU pattern 300 that supports random access for low-duty-cycle time division duplexing in wireless communications in accordance with one or more aspects of the present disclosure. The PRU pattern 300 may be implemented in accordance with one or more aspects of the wireless communications system 100. For example, a UE (e.g., a UE 115, which in some examples may be a NB-IoT device) may communicate over or via an NTN in accordance with the PRU pattern 300. In other words, the PRU pattern 300 may be associated with NTN communication between the UE and a network entity (e.g., a satellite) and may facilitate NB-IoT over an NTN.

The PRU pattern 300 may include a multiple PRUs 305, where each PRU 305 includes multiple symbol groups 310. Each symbol group 310 may include a cyclic prefix (CP) 315 and multiple data symbols 320. Repetitions of a PRACH preamble 325 may be transmitted in a frequency indicated by a preamble index 330 in symbol groups 310 of a PRU 305 in accordance with patterns that may be defined or configured for PRACH transmissions. It is to be understood that the PRU pattern 300 is just one example of numerous potential examples of PRACH patterns for transmission of random access preambles.

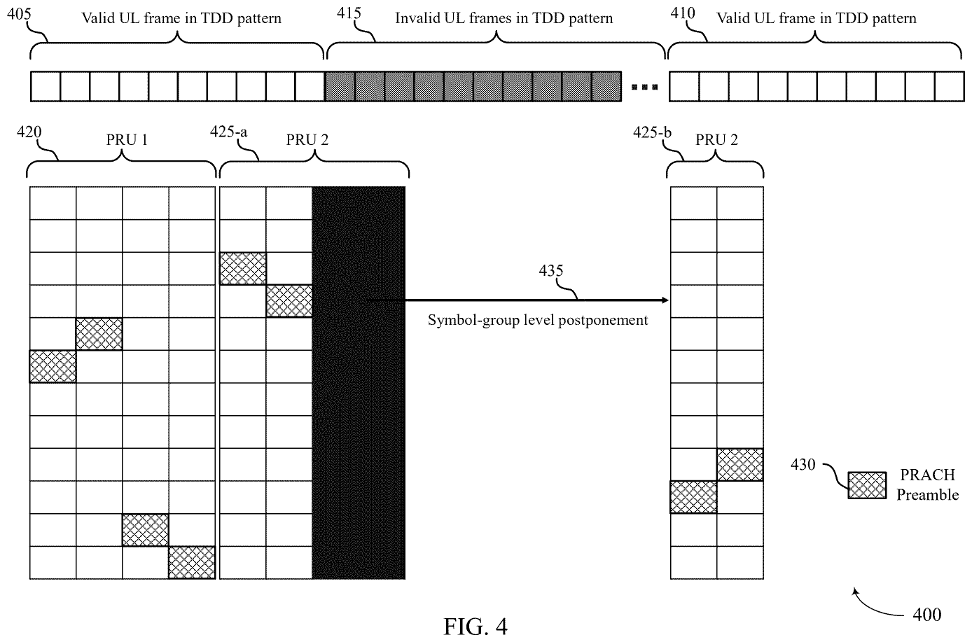

FIG. 4 shows an example of a deferred PRU pattern 400 that supports random access for low-duty-cycle time division duplexing in wireless communications in accordance with one or more aspects of the present disclosure. The deferred PRU pattern 400 may be implemented in accordance with one or more aspects of the wireless communications system 100. For example, a UE (e.g., a UE 115, which in some examples may be a NB-IoT device) may communicate over or via an NTN in accordance with the deferred PRU pattern 400. In other words, the deferred PRU pattern 400 may be associated with NTN communication between the UE and a network entity (e.g., a satellite) and may facilitate NB-IoT over an NTN.

In accordance with some aspects, a TDD configuration may provide a first valid uplink frame 405 and a second valid uplink frame 410, with multiple invalid uplink frames 415 therebetween. In some examples, a UE may be configured with PRACH repetitions such that PRACH preambles 430 may be transmitted in a first PRU 420 and a second PRU 425. In the example of FIG. 4, the second PRU 425 overlaps with a first invalid uplink frame 415, such that two symbol groups are not able to be transmitted by the UE. In some aspects, PRACH preambles 430 may be deferred when associated resources overlap with an invalid uplink frame 415. In some aspects, PRACH transmissions may be deferred at a symbol-group level, such that if a symbol group of a PRU overlaps with an invalid uplink occasion with respect to the TDD pattern, the PRACH is postponed to the next valid uplink transmission occasion from that symbol group onward. In the example of FIG. 4, a first portion of the second PRU 425-a may include resources that are in the first uplink frame 405, and associated PRACH preambles 430 may be transmitted, and a second portion of the second PRU 425-b may overlap with the invalid uplink frame 415, and the PRACH preambles 430 of the second portion of the second PRU 425-b may be transmitted in the second valid uplink frame 410, in accordance with symbol-group level postponement 435.

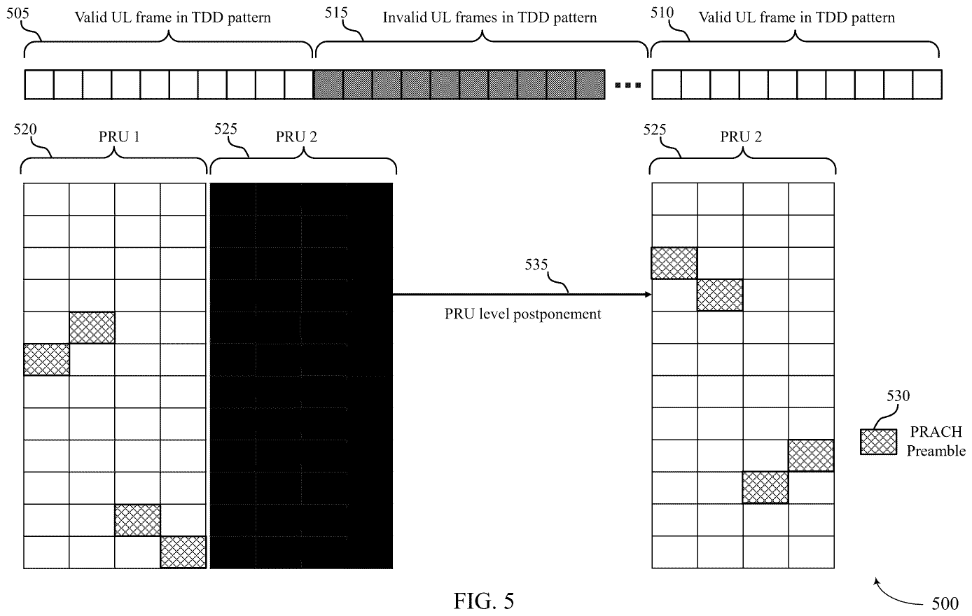

FIG. 5 shows an example of a deferred PRU pattern 500 that supports random access for low-duty-cycle time division duplexing in wireless communications in accordance with one or more aspects of the present disclosure. The deferred PRU pattern 500 may be implemented in accordance with one or more aspects of the wireless communications system 100. For example, a UE (e.g., a UE 115, which in some examples may be a NB-IoT device) may communicate over or via an NTN in accordance with the deferred PRU pattern 500. In other words, the deferred PRU pattern 500 may be associated with NTN communication between the UE and a network entity (e.g., a satellite) and may facilitate NB-IoT over an NTN.

In accordance with some aspects, a TDD configuration may provide a first valid uplink frame 505 and a second valid uplink frame 510, with multiple invalid uplink frames 515 therebetween. In some examples, a UE may be configured with PRACH repetitions such that PRACH preambles 530 may be transmitted in a first PRU 520 and a second PRU 525. In the example of FIG. 5, the second PRU 525 overlaps with a first invalid uplink frame 515. In some aspects, PRACH preambles 530 may be deferred when associated resources overlap with an invalid uplink frame 515. In some aspects, PRACH transmissions may be deferred at a PRU-level, such that if a symbol group of a PRU overlaps with an invalid uplink occasion with respect to the TDD pattern, the PRACH preambles 530 of the PRU in its entirety are postponed to the next valid uplink transmission occasion. In the example of FIG. 5, the second PRU 525 may overlap with the invalid uplink frame 515, and the PRACH preambles 530 of the second PRU 525 may be transmitted in the second valid uplink frame 510, in accordance with PRU level postponement 535. In some aspects, deferral of all PRACH preamble 530 transmissions of the second PRU 525 may allow some additional processing at the receiver (e.g., determination of timing and frequency offsets) to be preserved at the receiver, where symbol-level postponement may result in some processing that is unable to be performed due to the time gap between random access preamble transmissions.

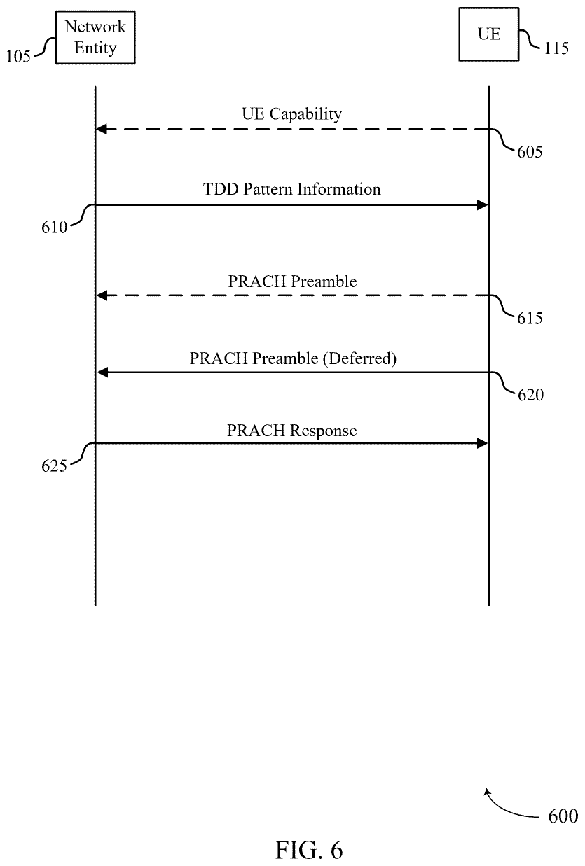

FIG. 6 shows an example of a process flow 600 that supports random access for low-duty-cycle time division duplexing in wireless communications in accordance with one or more aspects of the present disclosure. The process flow 600 may implement or be implemented to realize one or more aspects of the wireless communications system 100, the TDD pattern 200, or the PRU patterns 300, 400, or 500. For example, the process flow 600 illustrates communication between a UE 115 and a network entity 105, which may be examples of corresponding devices as illustrated and described herein, including by or with reference to FIGS. 1-5.

In the following description of the process flow 600, the operations may be performed (e.g., reported or provided) in a different order than the order shown, or the operations performed by the example devices may be performed in different orders or at different times. Some operations also may be left out of the process flow 600, or other operations may be added to the process flow 600. Further, although some operations or signaling may be shown to occur at different times for discussion purposes, these operations may actually occur at the same time.

Optionally, at 605, the UE 115 may transmit, and the network entity 105 may receive, information indicative of a capability of the UE 115. For example, the UE 115 may transmit an indication of a capability for low duty cycle TDD communications in which PRACH preamble transmissions may be deferred based on an overlap with an invalid uplink frame.

At 610, the network entity 105 may transmit, and the UE 115 may receive, information indicative of a TDD pattern (e.g., the TDD pattern 200). The information may indicate any one or more parameters associated with the TDD pattern, such as a downlink-uplink offset, a periodicity associated with valid (downlink or uplink) frames, or numeric value(s) of k or N in accordance with the TDD pattern being associated with a k out of N approach, among other aspects described herein. By way of example, k may be equal to any first numeric quantity (e.g., 1, 2, or 3, among other examples) and N may be equal to any second numeric quantity (e.g., 2, 6, or 10, among other examples). Each k valid uplink frames may be referred to herein as a set of valid uplink frames, with the TDD pattern being associated with multiple non-consecutive sets of valid uplink frames (such that, for example, a first k valid uplink frames are non-consecutive with a second k valid uplink frames). Sets of valid uplink frames may be non-consecutive by way of being separated by one or more invalid uplink frames. A quantity of invalid uplink frames between two sets of valid uplink frames may be defined by or otherwise associated with N-k.

Optionally, at 615, the UE 115 may transmit a PRACH preamble using configured PRACH resources associated with a PRU within a valid uplink frame (e.g., in accordance with the periodicity of the valid uplink frames). In some aspects, the PRACH preamble transmission at 615 may be performed in accordance with a symbol-group level postponement of random access transmissions, as discussed herein.

At 620, the UE 115 may transmit one or more deferred PRACH preambles using configured PRACH resources associated with a PRU within a valid uplink frame (e.g., in accordance with the periodicity of the valid uplink frames). In some aspects, the PRACH preamble transmission at 620 may include PRACH preambles associated with a subset of symbol-groups of a PRU in accordance with a symbol-group level postponement of random access transmissions, as discussed herein. In other aspects, the PRACH preamble transmission at 620 may include all PRACH preambles associated with a PRU that overlaps with an invalid uplink frame in accordance with a PRU level postponement of random access transmissions, as discussed herein.

At 625, the network entity 105 may transmit, and the UE 115 may receive, a PRACH response. In some aspects, the network entity 105 may transmit the PRACH response using a RA-RNTI that is determined based on a SFN associated with either the initial uplink frame or the deferred uplink frame. In some aspects, the UE 115 and network entity 105 may exchange configuration information that indicates which uplink frame is to be used. In other aspects, the uplink frame to use for determining the RA-RNTI may be defined in a standard or other specification.

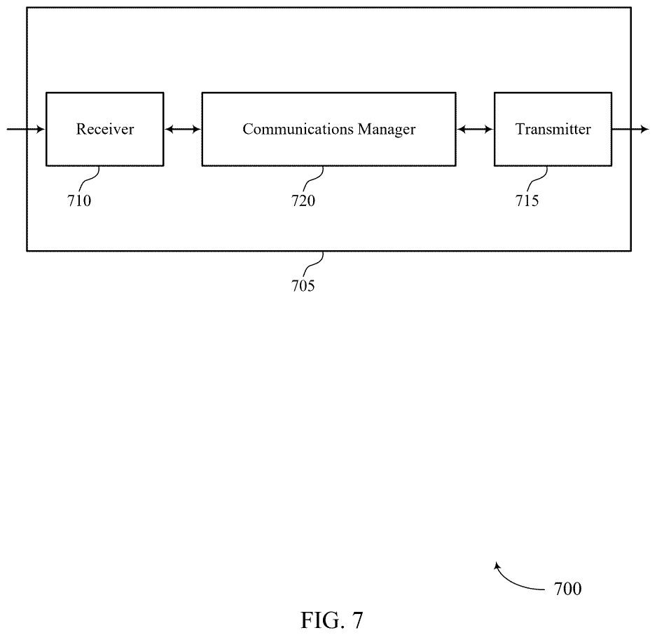

FIG. 7 shows a block diagram 700 of a device 705 that supports random access for low-duty-cycle time division duplexing in wireless communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to random access for low-duty-cycle time division duplexing in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to random access for low-duty-cycle time division duplexing in wireless communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of random access for low-duty-cycle time division duplexing in wireless communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The communications manager 720 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The communications manager 720 is capable of, configured to, or operable to support a means for deferring transmission of at least a portion of a first preamble repetition unit from the first uplink frame to the second uplink frame based on one or more symbol groups of the first preamble repetition unit that is selected for transmission of a random access preamble overlapping with the first invalid subframe. The communications manager 720 is capable of, configured to, or operable to support a means for transmitting at least the portion of the first preamble repetition unit in the second uplink frame.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for improved communication reliability, reduced latency, more efficient utilization of communication resources, improved coordination between devices, longer battery life, and improved utilization of processing capability, among other benefits.

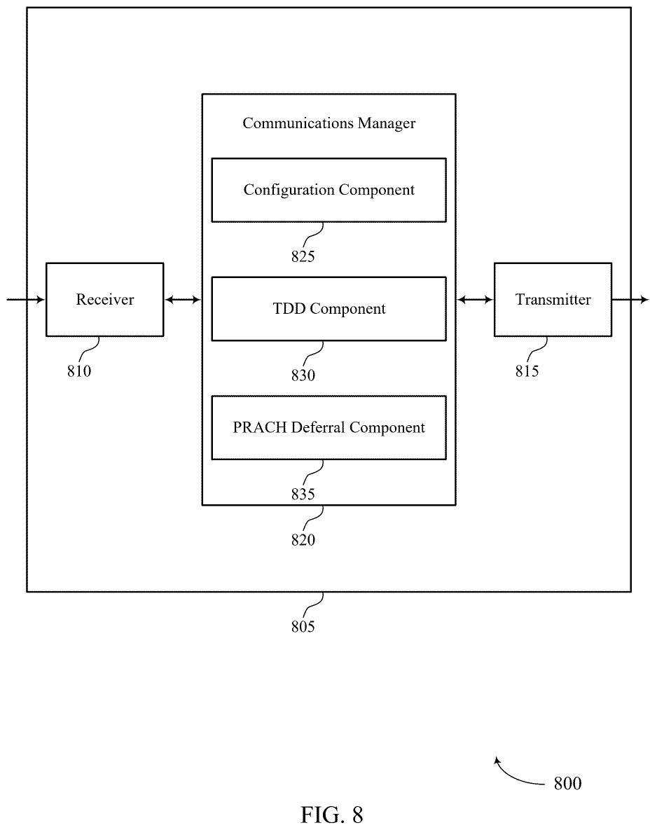

FIG. 8 shows a block diagram 800 of a device 805 that supports random access for low-duty-cycle time division duplexing in wireless communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to random access for low-duty-cycle time division duplexing in wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to random access for low-duty-cycle time division duplexing in wireless communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of random access for low-duty-cycle time division duplexing in wireless communications as described herein. For example, the communications manager 820 may include a configuration component 825, a TDD component 830, a PRACH deferral component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The TDD component 830 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The PRACH deferral component 835 is capable of, configured to, or operable to support a means for deferring transmission of at least a portion of a first preamble repetition unit from the first uplink frame to the second uplink frame based on one or more symbol groups of the first preamble repetition unit that is selected for transmission of a random access preamble overlapping with the first invalid subframe. The PRACH deferral component 835 is capable of, configured to, or operable to support a means for transmitting at least the portion of the first preamble repetition unit in the second uplink frame.

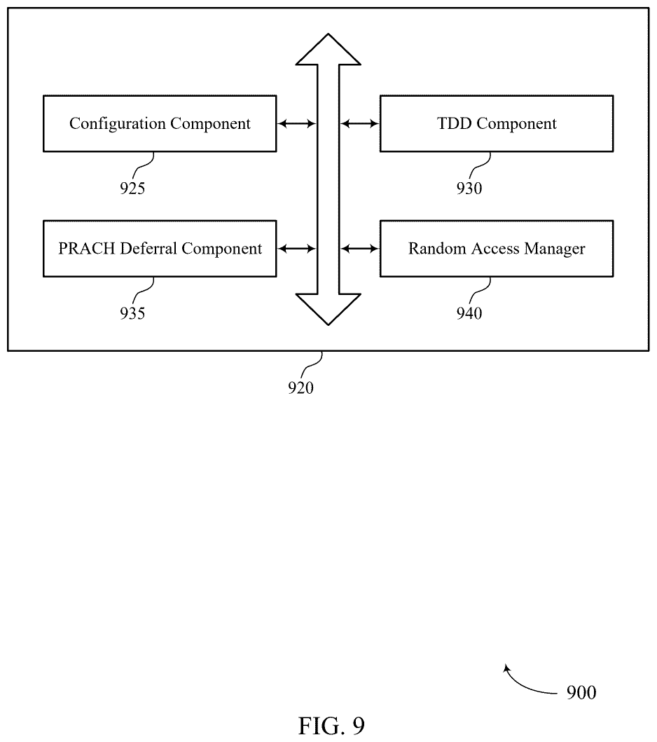

FIG. 9 shows a block diagram 900 of a communications manager 920 that supports random access for low-duty-cycle time division duplexing in wireless communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of random access for low-duty-cycle time division duplexing in wireless communications as described herein. For example, the communications manager 920 may include a configuration component 925, a TDD component 930, a PRACH deferral component 935, a random access manager 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The TDD component 930 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The PRACH deferral component 935 is capable of, configured to, or operable to support a means for deferring transmission of at least a portion of a first preamble repetition unit from the first uplink frame to the second uplink frame based on one or more symbol groups of the first preamble repetition unit that is selected for transmission of a random access preamble overlapping with the first invalid subframe. In some examples, the PRACH deferral component 935 is capable of, configured to, or operable to support a means for transmitting at least the portion of the first preamble repetition unit in the second uplink frame.

In some examples, to support deferring, the PRACH deferral component 935 is capable of, configured to, or operable to support a means for determining that at least a first symbol group of the first preamble repetition unit is within the first uplink frame and that at least a second symbol group of the first preamble repetition unit overlaps with the first invalid subframe. In some examples, to support deferring, the PRACH deferral component 935 is capable of, configured to, or operable to support a means for transmitting the first symbol group of the first preamble repetition unit. In some examples, to support deferring, the PRACH deferral component 935 is capable of, configured to, or operable to support a means for deferring transmission of the second symbol group to the second uplink frame.

In some examples, to support deferring, the PRACH deferral component 935 is capable of, configured to, or operable to support a means for determining that at least a first symbol group of the first preamble repetition unit is within the first uplink frame and that at least a second symbol group of the first preamble repetition unit overlaps with the first invalid subframe. In some examples, to support deferring, the PRACH deferral component 935 is capable of, configured to, or operable to support a means for deferring transmission of the first preamble repetition unit in its entirety to the second uplink frame.

In some examples, a non-integer quantity of preamble repetition units can be transmitted in each valid uplink frame.

In some examples, the random access manager 940 is capable of, configured to, or operable to support a means for monitoring for a random access response associated with the random access preamble based on a random access (RA) radio network temporary identifier (RNTI) that is identified based on the first preamble repetition unit used for transmission of the random access preamble.

In some examples, the RA-RNTI is identified based on a system frame number (SFN) identifier associated with the first uplink frame.

In some examples, the RA-RNTI is identified based on a system frame number (SFN) identifier associated with the second uplink frame.

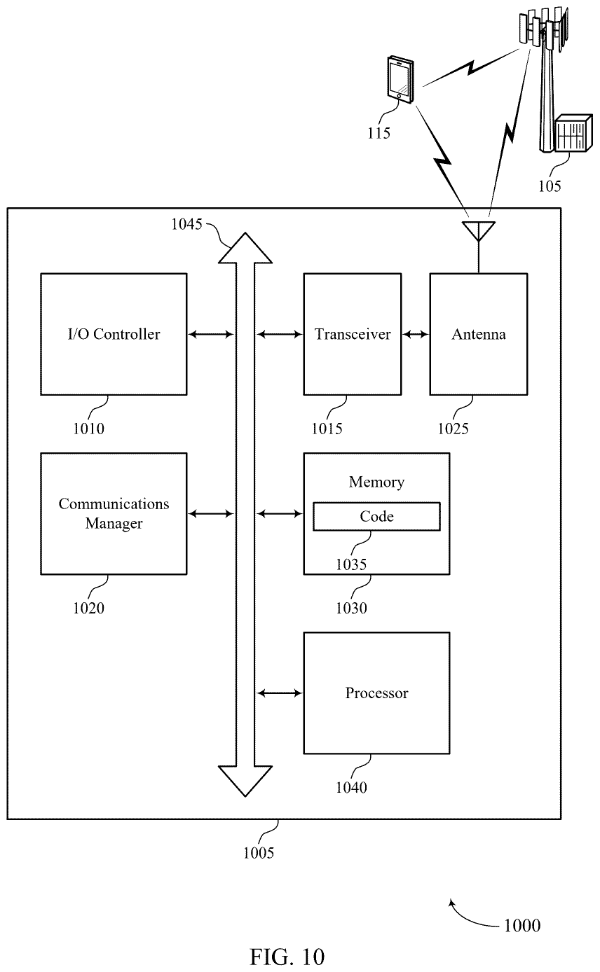

FIG. 10 shows a diagram of a system 1000 including a device 1005 that supports random access for low-duty-cycle time division duplexing in wireless communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting random access for low-duty-cycle time division duplexing in wireless communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The communications manager 1020 is capable of, configured to, or operable to support a means for determining a time division duplexing configuration that indicates a first set of valid frames for uplink communications and a second set of invalid subframes for uplink communications, where at least a first invalid subframe is located between a first uplink frame and a second uplink frame of the first set of valid subframes. The communications manager 1020 is capable of, configured to, or operable to support a means for deferring transmission of at least a portion of a first preamble repetition unit from the first uplink frame to the second uplink frame based on one or more symbol groups of the first preamble repetition unit that is selected for transmission of a random access preamble overlapping with the first invalid subframe. The communications manager 1020 is capable of, configured to, or operable to support a means for transmitting at least the portion of the first preamble repetition unit in the second uplink frame.

By including or configuring the communications manager 1020 in accordance with examples as described herein, the device 1005 may support techniques for improved communication reliability, reduced latency, more efficient utilization of communication resources, improved coordination between devices, longer battery life, and improved utilization of processing capability, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of random access for low-duty-cycle time division duplexing in wireless communications as described herein, or the at least one processor 1040 and the at least one memory 1030 may be otherwise configured to, individually or collectively, perform or support such operations.

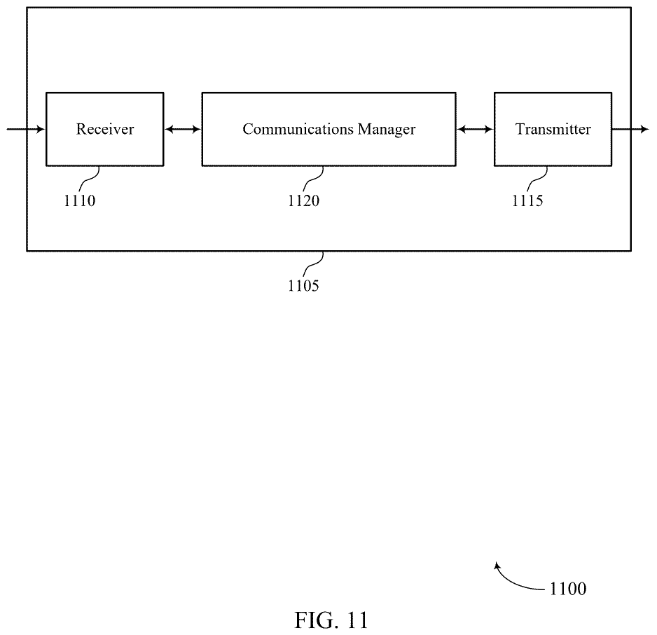

FIG. 11 shows a block diagram 1100 of a device 1105 that supports random access for low-duty-cycle time division duplexing in wireless communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of random access for low-duty-cycle time division duplexing in wireless communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The communications manager 1120 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The communications manager 1120 is capable of, configured to, or operable to support a means for obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for improved communication reliability, reduced latency, more efficient utilization of communication resources, improved coordination between devices, longer battery life, and improved utilization of processing capability, among other benefits.

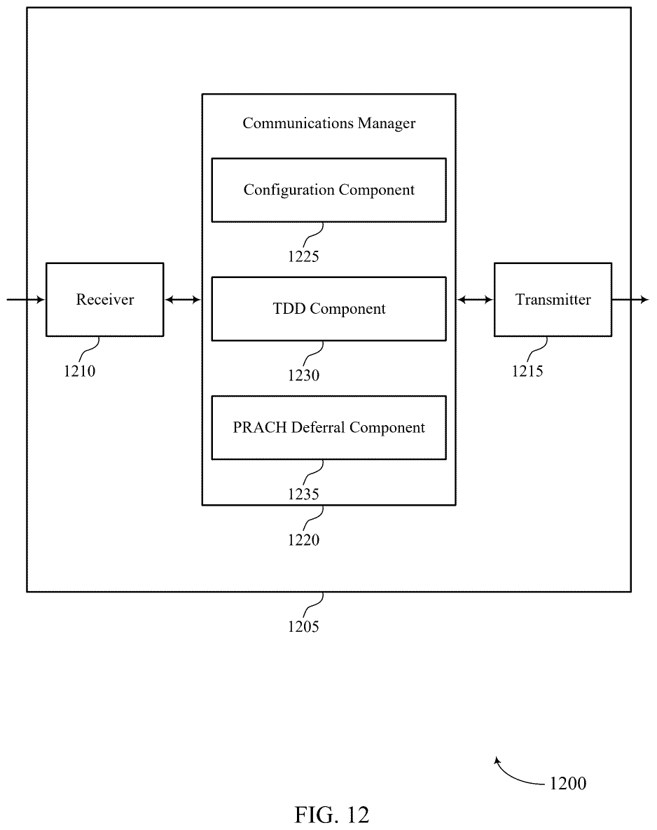

FIG. 12 shows a block diagram 1200 of a device 1205 that supports random access for low-duty-cycle time division duplexing in wireless communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of random access for low-duty-cycle time division duplexing in wireless communications as described herein. For example, the communications manager 1220 may include a configuration component 1225, a TDD component 1230, a PRACH deferral component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The TDD component 1230 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The PRACH deferral component 1235 is capable of, configured to, or operable to support a means for obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

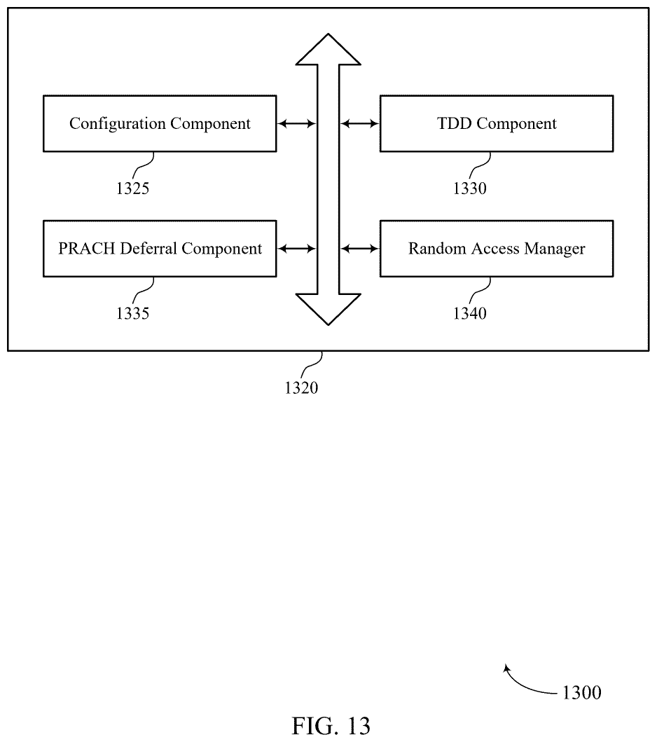

FIG. 13 shows a block diagram 1300 of a communications manager 1320 that supports random access for low-duty-cycle time division duplexing in wireless communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of random access for low-duty-cycle time division duplexing in wireless communications as described herein. For example, the communications manager 1320 may include a configuration component 1325, a TDD component 1330, a PRACH deferral component 1335, a random access manager 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The TDD component 1330 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The PRACH deferral component 1335 is capable of, configured to, or operable to support a means for obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

In some examples, to support obtaining, the PRACH deferral component 1335 is capable of, configured to, or operable to support a means for determining that at least a first symbol group of the first preamble repetition unit is within the first uplink frame and that at least a second symbol group of the first preamble repetition unit overlaps with the first invalid subframe. In some examples, to support obtaining, the PRACH deferral component 1335 is capable of, configured to, or operable to support a means for obtaining the first symbol group of the first preamble repetition unit via the first uplink frame. In some examples, to support obtaining, the PRACH deferral component 1335 is capable of, configured to, or operable to support a means for obtaining the second symbol group of the first preamble repetition unit via the second uplink frame.

In some examples, to support obtaining the random access message, the PRACH deferral component 1335 is capable of, configured to, or operable to support a means for determining that at least a first symbol group of the first preamble repetition unit is within the first uplink frame and that at least a second symbol group of the first preamble repetition unit overlaps with the first invalid subframe. In some examples, to support obtaining the random access message, the PRACH deferral component 1335 is capable of, configured to, or operable to support a means for obtaining the first preamble repetition unit in its entirety via the second uplink frame.

In some examples, a non-integer quantity of preamble repetition units can be transmitted in each valid uplink frame.

In some examples, the random access manager 1340 is capable of, configured to, or operable to support a means for outputting a random access response associated with the random access preamble based on a random access (RA) radio network temporary identifier (RNTI) that is identified based on the first preamble repetition unit used for transmission of the random access preamble.

In some examples, the RA-RNTI is identified based on a system frame number (SFN) identifier associated with the first uplink frame.

In some examples, the RA-RNTI is identified based on a system frame number (SFN) identifier associated with the second uplink frame.

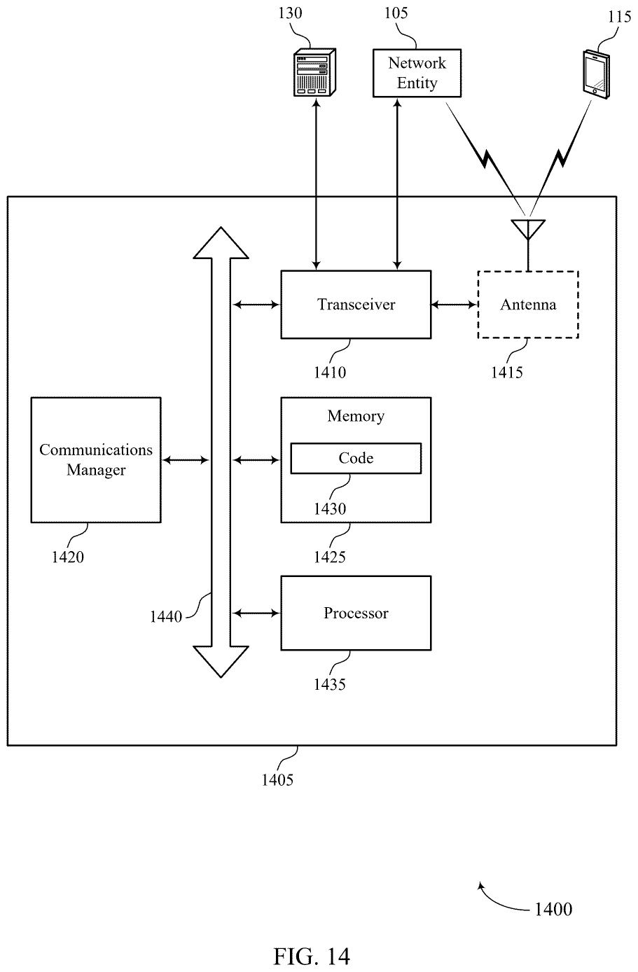

FIG. 14 shows a diagram of a system 1400 including a device 1405 that supports random access for low-duty-cycle time division duplexing in wireless communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting random access for low-duty-cycle time division duplexing in wireless communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The communications manager 1420 is capable of, configured to, or operable to support a means for determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The communications manager 1420 is capable of, configured to, or operable to support a means for obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe.

By including or configuring the communications manager 1420 in accordance with examples as described herein, the device 1405 may support techniques for improved communication reliability, reduced latency, more efficient utilization of communication resources, improved coordination between devices, longer battery life, and improved utilization of processing capability, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of random access for low-duty-cycle time division duplexing in wireless communications as described herein, or the at least one processor 1435 and the at least one memory 1425 may be otherwise configured to, individually or collectively, perform or support such operations.

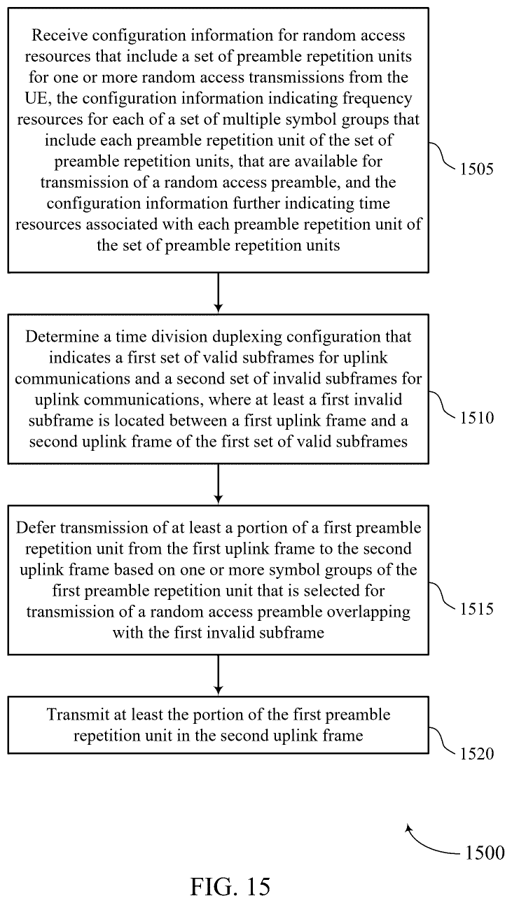

FIG. 15 shows a flowchart illustrating a method 1500 that supports random access for low-duty-cycle time division duplexing in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 1505 may be performed in accordance with examples as disclosed herein. In some examples, aspects of the operations of 1505 may be performed by a configuration component 925 as described with reference to FIG. 9.

At 1510, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 1510 may be performed in accordance with examples as disclosed herein. In some examples, aspects of the operations of 1510 may be performed by a TDD component 930 as described with reference to FIG. 9.

At 1515, the method may include deferring transmission of at least a portion of a first preamble repetition unit from the first uplink frame to the second uplink frame based on one or more symbol groups of the first preamble repetition unit that is selected for transmission of a random access preamble overlapping with the first invalid subframe. The operations of 1515 may be performed in accordance with examples as disclosed herein. In some examples, aspects of the operations of 1515 may be performed by a PRACH deferral component 935 as described with reference to FIG. 9.

At 1520, the method may include transmitting at least the portion of the first preamble repetition unit in the second uplink frame. The operations of 1520 may be performed in accordance with examples as disclosed herein. In some examples, aspects of the operations of 1520 may be performed by a PRACH deferral component 935 as described with reference to FIG. 9.

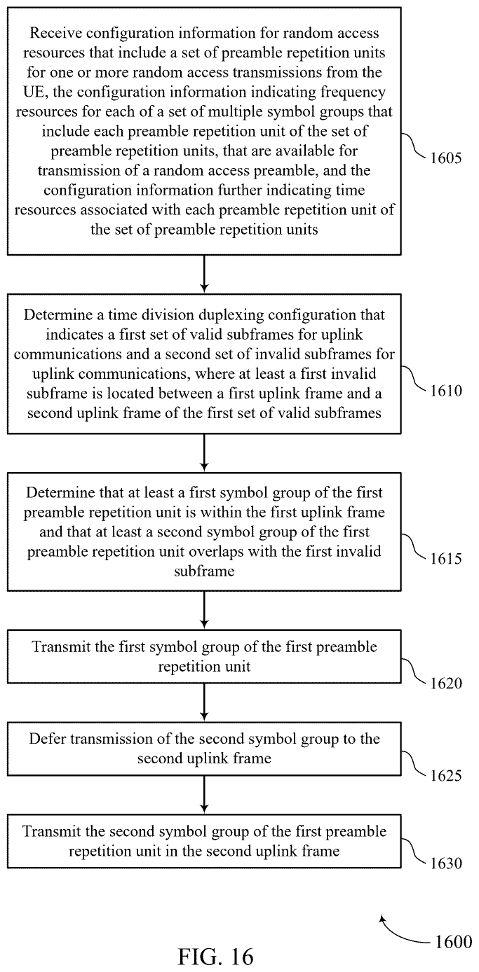

FIG. 16 shows a flowchart illustrating a method 1600 that supports random access for low-duty-cycle time division duplexing in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 1605 may be performed in accordance with examples as disclosed herein. In some examples, aspects of the operations of 1605 may be performed by a configuration component 925 as described with reference to FIG. 9.

At 1610, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 1610 may be performed in accordance with examples as disclosed herein. In some examples, aspects of the operations of 1610 may be performed by a TDD component 930 as described with reference to FIG. 9.

At 1615, the method may include determining that at least a first symbol group of the first preamble repetition unit is within the first uplink frame and that at least a second symbol group of the first preamble repetition unit overlaps with the first invalid subframe. The operations of 1615 may be performed in accordance with examples as disclosed herein. In some examples, aspects of the operations of 1615 may be performed by a PRACH deferral component 935 as described with reference to FIG. 9.

At 1620, the method may include transmitting the first symbol group of the first preamble repetition unit. The operations of 1620 may be performed in accordance with examples as disclosed herein. In some examples, aspects of the operations of 1620 may be performed by a PRACH deferral component 935 as described with reference to FIG. 9.

At 1625, the method may include deferring transmission of the second symbol group to the second uplink frame. The operations of 1625 may be performed in accordance with examples as disclosed herein. In some examples, aspects of the operations of 1625 may be performed by a PRACH deferral component 935 as described with reference to FIG. 9.

At 1630, the method may include transmitting the second symbol group of the first preamble repetition unit in the second uplink frame. The operations of 1630 may be performed in accordance with examples as disclosed herein. In some examples, aspects of the operations of 1630 may be performed by a PRACH deferral component 935 as described with reference to FIG. 9.

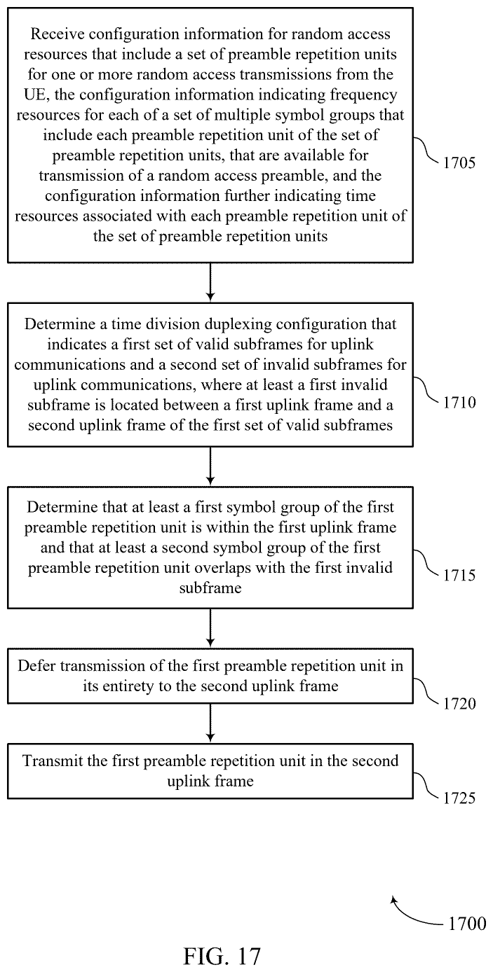

FIG. 17 shows a flowchart illustrating a method 1700 that supports random access for low-duty-cycle time division duplexing in wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 1705 may be performed in accordance with examples as disclosed herein. In some examples, aspects of the operations of 1705 may be performed by a configuration component 925 as described with reference to FIG. 9.

At 1710, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 1710 may be performed in accordance with examples as disclosed herein. In some examples, aspects of the operations of 1710 may be performed by a TDD component 930 as described with reference to FIG. 9.

At 1715, the method may include determining that at least a first symbol group of the first preamble repetition unit is within the first uplink frame and that at least a second symbol group of the first preamble repetition unit overlaps with the first invalid subframe. The operations of 1715 may be performed in accordance with examples as disclosed herein. In some examples, aspects of the operations of 1715 may be performed by a PRACH deferral component 935 as described with reference to FIG. 9.

At 1720, the method may include deferring transmission of the first preamble repetition unit in its entirety to the second uplink frame. The operations of 1720 may be performed in accordance with examples as disclosed herein. In some examples, aspects of the operations of 1720 may be performed by a PRACH deferral component 935 as described with reference to FIG. 9.

At 1725, the method may include transmitting the first preamble repetition unit in the second uplink frame. The operations of 1725 may be performed in accordance with examples as disclosed herein. In some examples, aspects of the operations of 1725 may be performed by a PRACH deferral component 935 as described with reference to FIG. 9.

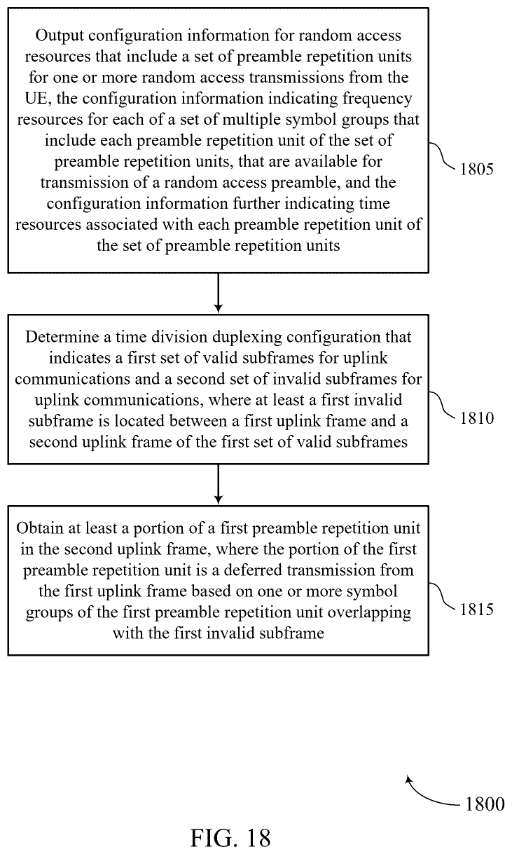

FIG. 18 shows a flowchart illustrating a method 1800 that supports random access for low-duty-cycle time division duplexing in wireless communications in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 1805 may be performed in accordance with examples as disclosed herein. In some examples, aspects of the operations of 1805 may be performed by a configuration component 1325 as described with reference to FIG. 13.

At 1810, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 1810 may be performed in accordance with examples as disclosed herein. In some examples, aspects of the operations of 1810 may be performed by a TDD component 1330 as described with reference to FIG. 13.

At 1815, the method may include obtaining at least a portion of a first preamble repetition unit in the second uplink frame, where the portion of the first preamble repetition unit is a deferred transmission from the first uplink frame based on one or more symbol groups of the first preamble repetition unit overlapping with the first invalid subframe. The operations of 1815 may be performed in accordance with examples as disclosed herein. In some examples, aspects of the operations of 1815 may be performed by a PRACH deferral component 1335 as described with reference to FIG. 13.

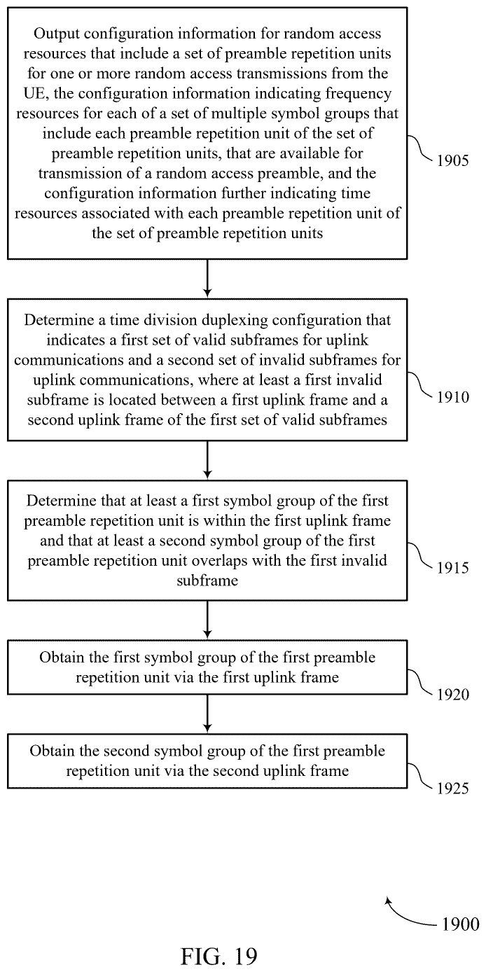

FIG. 19 shows a flowchart illustrating a method 1900 that supports random access for low-duty-cycle time division duplexing in wireless communications in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 1905 may be performed in accordance with examples as disclosed herein. In some examples, aspects of the operations of 1905 may be performed by a configuration component 1325 as described with reference to FIG. 13.

At 1910, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 1910 may be performed in accordance with examples as disclosed herein. In some examples, aspects of the operations of 1910 may be performed by a TDD component 1330 as described with reference to FIG. 13.

At 1915, the method may include determining that at least a first symbol group of the first preamble repetition unit is within the first uplink frame and that at least a second symbol group of the first preamble repetition unit overlaps with the first invalid subframe. The operations of 1915 may be performed in accordance with examples as disclosed herein. In some examples, aspects of the operations of 1915 may be performed by a PRACH deferral component 1335 as described with reference to FIG. 13.

At 1920, the method may include obtaining the first symbol group of the first preamble repetition unit via the first uplink frame. The operations of 1920 may be performed in accordance with examples as disclosed herein. In some examples, aspects of the operations of 1920 may be performed by a PRACH deferral component 1335 as described with reference to FIG. 13.

At 1925, the method may include obtaining the second symbol group of the first preamble repetition unit via the second uplink frame. The operations of 1925 may be performed in accordance with examples as disclosed herein. In some examples, aspects of the operations of 1925 may be performed by a PRACH deferral component 1335 as described with reference to FIG. 13.

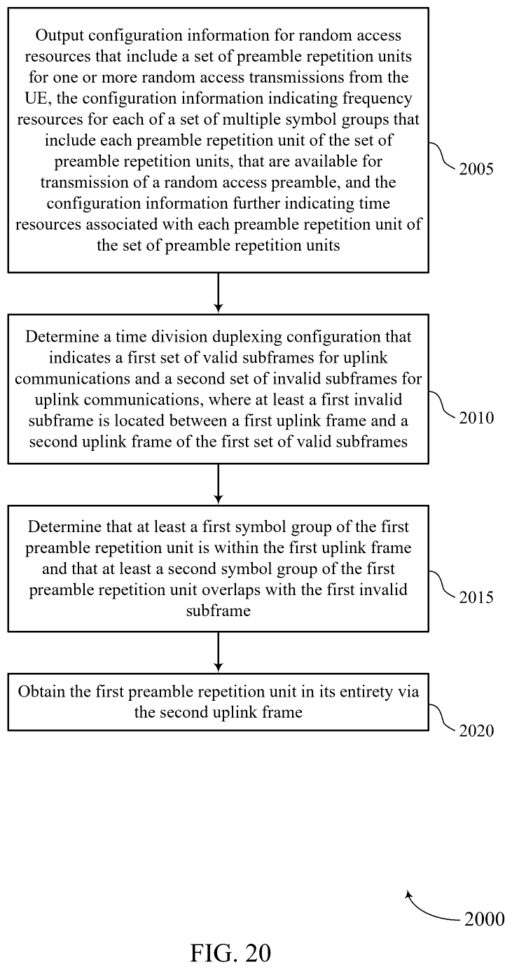

FIG. 20 shows a flowchart illustrating a method 2000 that supports random access for low-duty-cycle time division duplexing in wireless communications in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include outputting configuration information for random access resources that include a set of preamble repetition units for one or more random access transmissions from the UE, the configuration information indicating frequency resources for each of a set of multiple symbol groups that include each preamble repetition unit of the set of preamble repetition units, that are available for transmission of a random access preamble, and the configuration information further indicating time resources associated with each preamble repetition unit of the set of preamble repetition units. The operations of 2005 may be performed in accordance with examples as disclosed herein. In some examples, aspects of the operations of 2005 may be performed by a configuration component 1325 as described with reference to FIG. 13.

At 2010, the method may include determining a time division duplexing configuration that indicates a first set of valid subframes for uplink communications and a second set of invalid subframes for uplink communications, where at least a first invalid subframe is located between a first uplink frame and a second uplink frame of the first set of valid subframes. The operations of 2010 may be performed in accordance with examples as disclosed herein. In some examples, aspects of the operations of 2010 may be performed by a TDD component 1330 as described with reference to FIG. 13.

At 2015, the method may include determining that at least a first symbol group of the first preamble repetition unit is within the first uplink frame and that at least a second symbol group of the first preamble repetition unit overlaps with the first invalid subframe. The operations of 2015 may be performed in accordance with examples as disclosed herein. In some examples, aspects of the operations of 2015 may be performed by a PRACH deferral component 1335 as described with reference to FIG. 13.

At 2020, the method may include obtaining the first preamble repetition unit in its entirety via the second uplink frame. The operations of 2020 may be performed in accordance with examples as disclosed herein. In some examples, aspects of the operations of 2020 may be performed by a PRACH deferral component 1335 as described with reference to FIG. 13.

The following provides an overview of aspects of the present disclosure:

Aspect 1: A method for wireless communications at a UE, comprising: receiving configuration information for random access resources that comprise a set of preamble repetition units for one or more random access transmissions from the UE, the configuration information indicating frequency resources for each of a plurality of symbol groups that comprise each preamble repetition unit of the set of preamble repetition units, that are available for transmission of a random access preamble, and the configuration information further indicating time resources associated with each preamble repetition unit of the set of preamble repetition units; determining a time division duplexing configuration that indicates a first set of valid subframes for uplink communications and a second set of invalid subframes for uplink communications, wherein at least a first invalid subframe is located between a first uplink frame and a second uplink frame of the first set of valid subframes; deferring transmission of at least a portion of a first preamble repetition unit from the first uplink frame to the second uplink frame based at least in part on one or more symbol groups of the first preamble repetition unit that is selected for transmission of a random access preamble overlapping with the first invalid subframe; and transmitting at least the portion of the first preamble repetition unit in the second uplink frame.

Aspect 2: The method of aspect 1, wherein the deferring comprises: determining that at least a first symbol group of the first preamble repetition unit is within the first uplink frame and that at least a second symbol group of the first preamble repetition unit overlaps with the first invalid subframe; transmitting the first symbol group of the first preamble repetition unit; and deferring transmission of the second symbol group to the second uplink frame.

Aspect 3: The method of aspect 1, wherein the deferring comprises: determining that at least a first symbol group of the first preamble repetition unit is within the first uplink frame and that at least a second symbol group of the first preamble repetition unit overlaps with the first invalid subframe; and deferring transmission of the first preamble repetition unit in its entirety to the second uplink frame.

Aspect 4: The method of any of aspects 1 through 3, wherein a non-integer quantity of preamble repetition units can be transmitted in each valid uplink frame.

Aspect 5: The method of any of aspects 1 through 4, further comprising: monitoring for a random access response associated with the random access preamble based at least in part on a RA-RNTI that is identified based at least in part on the first preamble repetition unit used for transmission of the random access preamble.

Aspect 6: The method of aspect 5, wherein the RA-RNTI is identified based at least in part on a SFN identifier associated with the first uplink frame.

Aspect 7: The method of aspect 5, wherein the RA-RNTI is identified based at least in part on a SFN identifier associated with the second uplink frame.

Aspect 8: A method for wireless communications at a network entity, comprising: outputting configuration information for random access resources that comprise a set of preamble repetition units for one or more random access transmissions from the UE, the configuration information indicating frequency resources for each of a plurality of symbol groups that comprise each preamble repetition unit of the set of preamble repetition units, that are available for transmission of a random access preamble, and the configuration information further indicating time resources associated with each preamble repetition unit of the set of preamble repetition units; determining a time division duplexing configuration that indicates a first set of valid subframes for uplink communications and a second set of invalid subframes for uplink communications, wherein at least a first invalid subframe is located between a first uplink frame and a second uplink frame of the first set of valid subframes; and obtaining at least a portion of a first preamble repetition unit in the second uplink frame, wherein the portion of the first preamble repetition unit is a deferred transmission from the first uplink frame based at least in part on one or more symbol groups of the first preamble repetition unit overlapping with the first invalid subframe.

Aspect 9: The method of aspect 8, wherein the obtaining comprises: determining that at least a first symbol group of the first preamble repetition unit is within the first uplink frame and that at least a second symbol group of the first preamble repetition unit overlaps with the first invalid subframe; obtaining the first symbol group of the first preamble repetition unit via the first uplink frame; and obtaining the second symbol group of the first preamble repetition unit via the second uplink frame.

Aspect 10: The method of aspect 8, wherein the obtaining the random access message comprises: determining that at least a first symbol group of the first preamble repetition unit is within the first uplink frame and that at least a second symbol group of the first preamble repetition unit overlaps with the first invalid subframe; and obtaining the first preamble repetition unit in its entirety via the second uplink frame.

Aspect 11: The method of any of aspects 8 through 10, wherein a non-integer quantity of preamble repetition units can be transmitted in each valid uplink frame.

Aspect 12: The method of any of aspects 8 through 11, further comprising:

outputting a random access response associated with the random access preamble based at least in part on a RA-RNTI that is identified based at least in part on the first preamble repetition unit used for transmission of the random access preamble.

Aspect 13: The method of aspect 12, wherein the RA-RNTI is identified based at least in part on a SFN identifier associated with the first uplink frame.

Aspect 14: The method of aspect 12, wherein the RA-RNTI is identified based at least in part on a SFN identifier associated with the second uplink frame.

Aspect 15: A UE for wireless communications, comprising one or more memories storing processor-executable code, and one or more processors coupled with the one or more memories and individually or collectively operable to execute the code to cause the UE to perform a method of any of aspects 1 through 7.

Aspect 16: A UE for wireless communications, comprising at least one means for performing a method of any of aspects 1 through 7.

Aspect 17: A non-transitory computer-readable medium storing code for wireless communications, the code comprising instructions executable by one or more processors to perform a method of any of aspects 1 through 7.

Aspect 18: A network entity for wireless communications, comprising one or more memories storing processor-executable code, and one or more processors coupled with the one or more memories and individually or collectively operable to execute the code to cause the network entity to perform a method of any of aspects 8 through 14.

Aspect 19: A network entity for wireless communications, comprising at least one means for performing a method of any of aspects 8 through 14.

Aspect 20: A non-transitory computer-readable medium storing code for wireless communications, the code comprising instructions executable by one or more processors to perform a method of any of aspects 8 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for random access resources that comprise a set of preamble repetition units for one or more random access transmissions from the UE, the configuration information indicating frequency resources for each of a plurality of symbol groups that comprise each preamble repetition unit of the set of preamble repetition units, that are available for transmission of a random access preamble, and the configuration information further indicating time resources associated with each preamble repetition unit of the set of preamble repetition units;
determine a time division duplexing configuration that indicates a first set of valid subframes for uplink communications and a second set of invalid subframes for uplink communications, wherein at least a first invalid subframe is located between the first set of valid subframes and a second set of valid subframes;
defer transmission of at least a portion of a first preamble repetition unit from the first set of valid subframes to the second set of valid subframes based at least in part on one or more symbol groups of the first preamble repetition unit that is selected for transmission of a random access preamble overlapping with the first invalid subframe; and
transmit at least the portion of the first preamble repetition unit in the second set of valid subframes.

2. The UE of claim 1, wherein, to defer transmission of at least the portion of the first preamble repetition unit, the one or more processors are individually or collectively operable to execute the code to cause the UE to:
determine that at least a first symbol group of the first preamble repetition unit is within the first set of valid subframes and that at least a second symbol group of the first preamble repetition unit overlaps with the second set of invalid subframes; and
defer transmission of the first preamble repetition unit in its entirety to the second set of valid subframes.

3. The UE of claim 1, wherein, to defer transmission of at least the portion of the first preamble repetition unit, the one or more processors are individually or collectively operable to execute the code to cause the UE to:
determine that at least a first symbol group of the first preamble repetition unit is within the first set of valid subframes and that at least a second symbol group of the first preamble repetition unit overlaps with the first invalid subframe;
transmit the first symbol group of the first preamble repetition unit; and
defer transmission of the second symbol group to the second set of valid subframes.

4. The UE of claim 1, wherein a non-integer quantity of preamble repetition units can be transmitted in each set of valid subframes.

5. The UE of claim 1, wherein the one or more processors are individually or collectively further operable to execute the code to cause the UE to:
monitor for a random access response associated with the random access preamble based at least in part on a random access (RA) radio network temporary identifier (RNTI) that is identified based at least in part on the first preamble repetition unit used for transmission of the random access preamble.

6. The UE of claim 1, wherein the first preamble repetition unit is transmitted to a network entity via a non-terrestrial network.

7. The UE of claim 1, wherein the first preamble repetition unit is transmitted via a narrowband physical random access channel in accordance with the time division duplexing configuration.

8. A network entity, comprising:
one or more memories storing processor-executable code; and
one or more processors coupled with the one or more memories and individually or collectively operable to execute the code to cause the network entity to:
output configuration information for random access resources that comprise a set of preamble repetition units for one or more random access transmissions from a user equipment (UE), the configuration information indicating frequency resources for each of a plurality of symbol groups that comprise each preamble repetition unit of the set of preamble repetition units, that are available for transmission of a random access preamble, and the configuration information further indicating time resources associated with each preamble repetition unit of the set of preamble repetition units;
determine a time division duplexing configuration that indicates a first set of valid subframes for uplink communications and a second set of invalid subframes for uplink communications, wherein at least a first invalid subframe is located between the first set of valid subframes and a second set of valid subframes; and
obtain at least a portion of a first preamble repetition unit in the second set of valid subframes, wherein at least the portion of the first preamble repetition unit is a deferred transmission from the first set of valid subframes based at least in part on one or more symbol groups of the first preamble repetition unit overlapping with the first invalid subframe.

9. The network entity of claim 8, wherein, to obtain at least the portion of the first preamble repetition unit, the one or more processors are individually or collectively operable to execute the code to cause the network entity to:
determine that at least a first symbol group of the first preamble repetition unit is within the first set of valid subframes and that at least a second symbol group of the first preamble repetition unit overlaps with the first invalid subframe; and
obtain the first preamble repetition unit in its entirety via the second set of valid subframes.

10. The network entity of claim 8, wherein, to obtain at least the portion of the first preamble repetition unit, the one or more processors are individually or collectively operable to execute the code to cause the network entity to:
determine that at least a first symbol group of the first preamble repetition unit is within the first set of valid subframes and that at least a second symbol group of the first preamble repetition unit overlaps with the first invalid subframe;
obtain the first symbol group of the first preamble repetition unit via the first set of valid subframes; and
obtain the second symbol group of the first preamble repetition unit via the second set of valid subframes.

11. The network entity of claim 8, wherein a non-integer quantity of preamble repetition units can be transmitted in each set of valid subframes.

12. The network entity of claim 8, wherein the one or more processors are individually or collectively further operable to execute the code to cause the network entity to:
output a random access response associated with the random access preamble based at least in part on a random access (RA) radio network temporary identifier (RNTI) that is identified based at least in part on the first preamble repetition unit used for transmission of the random access preamble.

13. The network entity of claim 8, wherein the first preamble repetition unit is obtained via a non-terrestrial network.

14. The network entity of claim 8, wherein the first preamble repetition unit is obtained via a narrowband physical random access channel in accordance with the time division duplexing configuration.

15. A method for wireless communications at a user equipment (UE), comprising:
receiving configuration information for random access resources that comprise a set of preamble repetition units for one or more random access transmissions from the UE, the configuration information indicating frequency resources for each of a plurality of symbol groups that comprise each preamble repetition unit of the set of preamble repetition units, that are available for transmission of a random access preamble, and the configuration information further indicating time resources associated with each preamble repetition unit of the set of preamble repetition units;
determining a time division duplexing configuration that indicates a first set of valid subframes for uplink communications and a second set of invalid subframes for uplink communications, wherein at least a first invalid subframe is located between the first set of valid subframes and a second set of valid subframes;
deferring transmission of at least a portion of a first preamble repetition unit from the first set of valid subframes to the second set of valid subframes based at least in part on one or more symbol groups of the first preamble repetition unit that is selected for transmission of a random access preamble overlapping with the first invalid subframe; and
transmitting at least the portion of the first preamble repetition unit in the second set of valid subframes.

16. The method of claim 15, wherein the deferring comprises:
determining that at least a first symbol group of the first preamble repetition unit is within the first set of valid subframes and that at least a second symbol group of the first preamble repetition unit overlaps with the first invalid subframe; and
deferring transmission of the first preamble repetition unit in its entirety to the second set of valid subframes.

17. The method of claim 15, wherein the deferring comprises:
determining that at least a first symbol group of the first preamble repetition unit is within the first set of valid subframes and that at least a second symbol group of the first preamble repetition unit overlaps with the first invalid subframe;
transmitting the first symbol group of the first preamble repetition unit; and
deferring transmission of the second symbol group to the second set of valid subframes.

18. The method of claim 15, further comprising:
monitoring for a random access response associated with the random access preamble based at least in part on a random access (RA) radio network temporary identifier (RNTI) that is identified based at least in part on the first preamble repetition unit used for transmission of the random access preamble.

19. The method of claim 15, wherein:
the first preamble repetition unit is transmitted to a network entity via a non-terrestrial network.

20. The method of claim 15, wherein:
the first preamble repetition unit is transmitted via a narrowband physical random access channel in accordance with the time division duplexing configuration.
